(19) United States
(12) Patent Application Publication
(10) Pub. No.: US 2021/0072729 A1
(43) Pub. Date: Mar. 11, 2021

(54) CONTROL DEVICE OF PEBBLE BED SAUNA AND METHOD THEREOF

(71) Applicant: MU Global Holding Limited, Kowloon (HK)

(72) Inventor: Yen-Yen Niu, Kowloon (HK)

(21) Appl. No.: 16/565,489

(22) Filed: Sep. 10, 2019

(51) Int. Cl. G05B 19/4155; G06K 7/14; A61H 33/06

(52) U.S. Cl. CPC G05B 19/4155; G06K 7/1417; A61H 33/06; G05B 2219/50333; A61H 2201/0207; A61H 2201/169; A61H 2201/5012; A61H 2201/5043; A61H 2033/068

(57) ABSTRACT

A pebble bed sauna structurally includes a control body arranged on the pebble bed sauna and a scanning element arranged at one side of the control body. As such, a user may use a mobile electronic device to connect with a cloud server and may carry out a transaction operation in the cloud server to generate a control code transmitted to the mobile electronic device, and a scanning element may be operated to scan the control code, so that the control body transmits a message of the control code to the cloud server to allow the cloud server to generate a control signal through the control code for transmission to the control body, allowing the control body to control an operation of the pebble bed sauna by means of the control signal. Thus, the transaction operation can be carried out efficiently to enhance convenience and efficiency of use.

### TECHNICAL FIELD OF THE INVENTION

The present invention provides a control device of pebble bed sauna and a method thereof, which provide a faster and more efficient way of use.

### DESCRIPTION OF THE PRIOR ART

In a pebble bed sauna (also known as stone spa) shop, confirmation of a specific type and time of sauna or spa must be made with a counter clerk, and charge is first confirmed and then payment is made. An attendant then leads the way into an operation site, and an operator makes and sets operation controls to start the operation. The entire process is generally a traditional way of business transactions. This is surely a waste of human labor for modern people. In addition, users must wait for the counter clerk for brief instruction and introduction. This may require undesired queuing if there are a large number of consumers. This causes inconvenience for the consumers in respect of experience and feeling, and this is also very inefficient.

### SUMMARY OF THE INVENTION

The primary objective of the present invention is to conduct a transaction in a cloud server by using a mobile electronic device to generate a control code and to allow a pebble bed sauna control body to scan the control code to start up the pebble bed sauna, so as to achieve a fast, convenient, and efficient way of use.

To achieve the above objective, the present invention provides a main structure that comprises: a control body arranged on the pebble bed sauna, a scanning element arranged on the control body and in information connection with the control body, and a cloud server to which a mobile application program loaded in a mobile electronic device and the control body are wirelessly connectable.

With the above structural arrangement, a user first uses the mobile application program loaded in the mobile electronic device to connect with the cloud server and carries out a transaction operation in the cloud server, so that the cloud server generates a control code that is transmitted to the mobile electronic device and the mobile electronic device displays the control code on a screen. The user then places the control code in front of the scanning element to allow the scanning element to carry out a scanning operation for transmission to the control body, and the control body then further transmits a message of or involving the control code to the cloud server for confirmation. Once the message is confirmed, the cloud server transmits a control signal to the control body and if it is a correct control code, the control body starts an operation of the pebble bed sauna; and if it is an erroneous control code, no operation of the pebble bed sauna is started. This allows a user to do a quick transaction operation through the mobile electronic device and to confirm if the pebble bed sauna can be started by means a simple operation of scanning, so as to achieve fast and convenient control of the pebble bed sauna.

### BRIEF DESCRIPTION OF THE DRAWINGS

FIG. 1 is a schematic view illustrating connection.

FIG. 2 is a block diagram.

FIG. 3 is a flow chart illustrating steps.

FIG. 4 is a schematic view illustrating a transaction operation.

FIG. 5 is a schematic view illustrating two-dimensional displaying.

FIG. 6 is a schematic view illustrating scanning.

FIG. 7 is a schematic view illustrating connection according to another preferred embodiment.

FIG. 8 is a flow chart illustrating steps according to another preferred embodiment.

FIG. 9 is a schematic view illustrating setting according to another preferred embodiment.

FIG. 10 is a schematic view illustrating reminding according to another preferred embodiment.

FIG. 11 is a schematic view of a further preferred embodiment.

FIG. 12 is a flow chart illustrating steps according to a further preferred embodiment.

FIG. 13 is a schematic view illustrating adjusting according to a further preferred embodiment.

### DETAILED DESCRIPTION OF THE PREFERRED EMBODIMENT

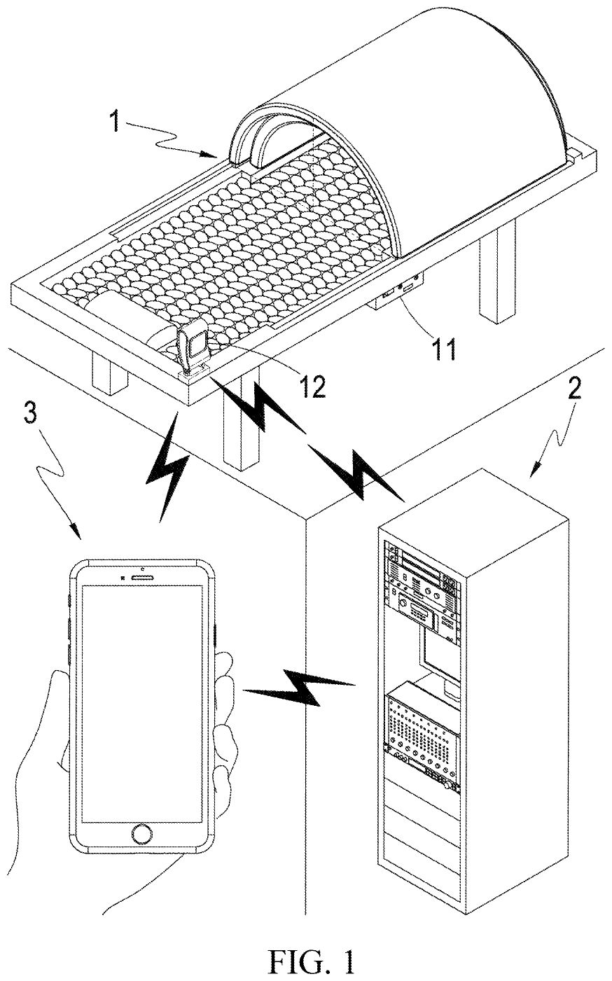

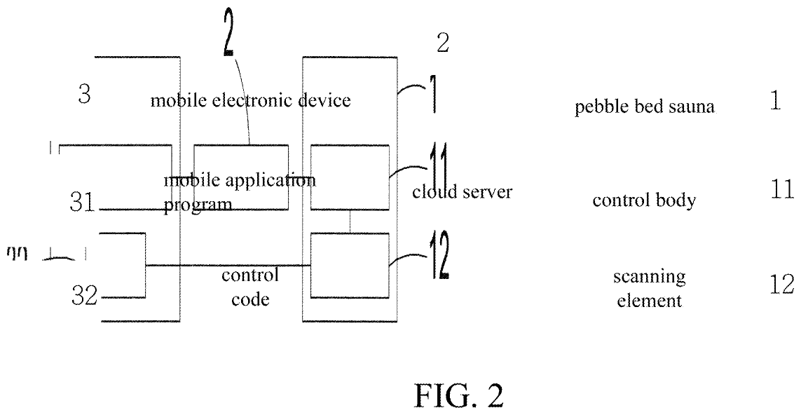

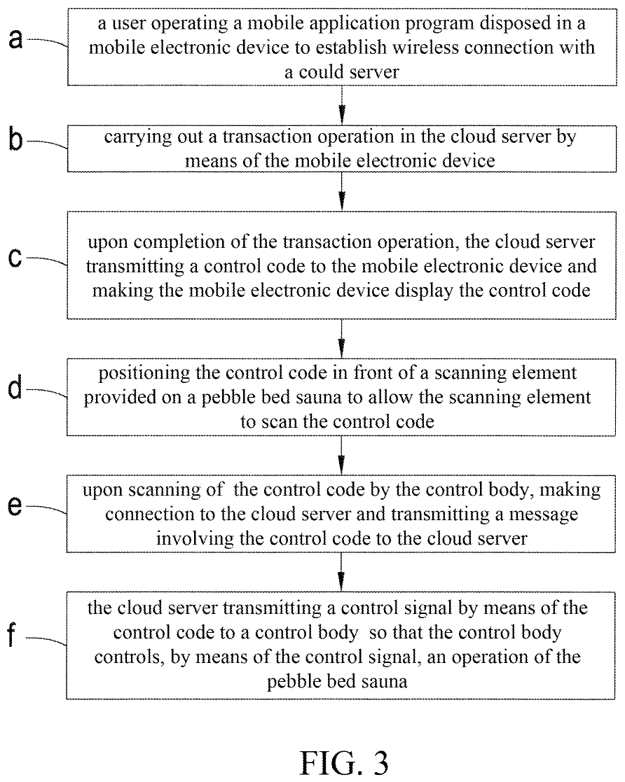

As shown in FIGS. 1-6, the drawings clearly show that the present invention comprises:

a control body 11 arranged on a pebble bed sauna 1, wherein in the instant embodiment, the control body 11 is a control box that controls operation of the pebble bed sauna 1;

a scanning element 12 arranged on the pebble bed sauna 1 and in information connection with the control body 11, wherein the scanning element 12 in the instant embodiment is a scanning lens provided on the pebble bed sauna 1;

a cloud server 2 to which the control body 11 and the mobile electronic device 3 are wirelessly connectable, wherein in the instant embodiment, an example of wireless connection is network connection; and

a mobile application program 31 disposed in the mobile electronic device 3, wherein the mobile electronic device 3 is wirelessly connectable with the cloud server 2 through the mobile application program 31.

A control method according to the present invention is as follows:

(a) a user operating a mobile application program disposed in a mobile electronic device to establish wireless connection with a cloud server;

(b) carrying out a transaction operation in the cloud server by means of the mobile electronic device;

(c) upon completion of the transaction operation, the cloud server transmitting a control code to the mobile electronic device and making the mobile electronic device display the control code;

(d) positioning the control code in front of a scanning element provided on a pebble bed sauna to allow the scanning element to scan the control code;

(e) upon scanning of the control code by the control body, making connection to the cloud server and transmitting a message involving the control code to the cloud server; and

(f) the cloud server transmitting a control signal by means of the control code to a control body, so that the control body controls, by means of the control signal, an operation of the pebble bed sauna.

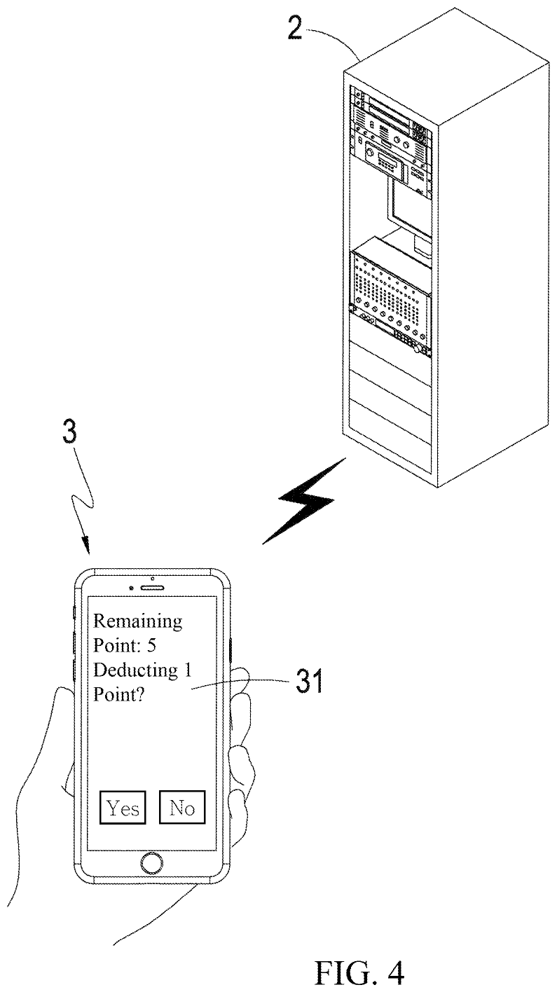

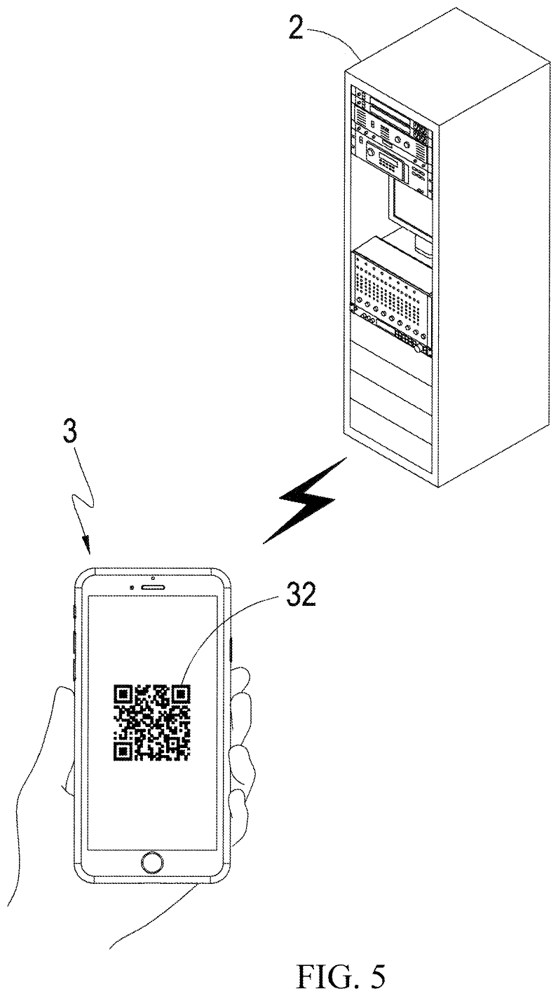

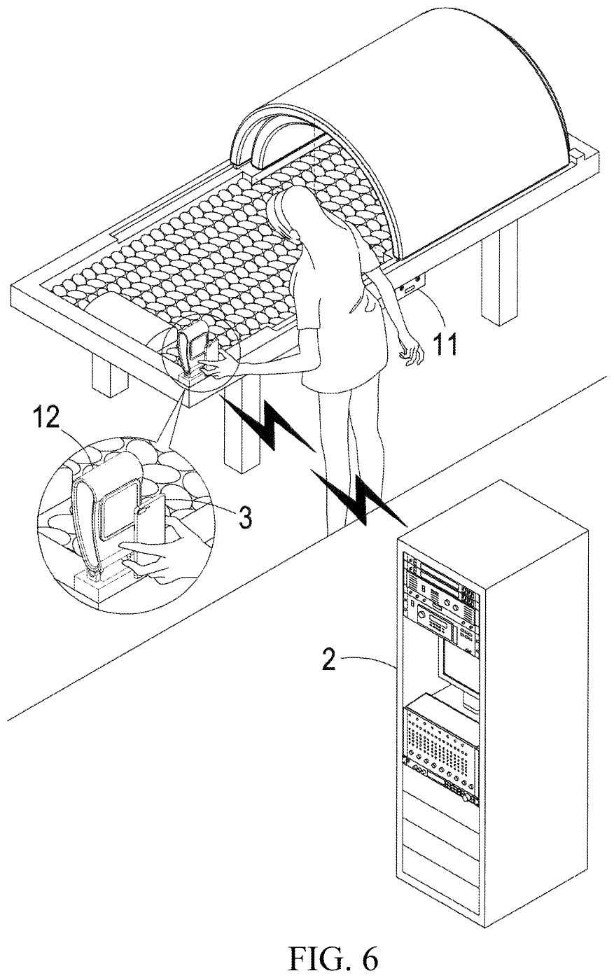

It can be appreciated from the above description that a user first uses the mobile application program 31 loaded in the mobile electronic device 3 to make wireless connection with the cloud server 2, and then, a transaction operation can be carried out with the mobile application program 31, wherein the transaction operation is not subjected to any limitation and can be one of transaction point, transaction balance, and on-line payment, and in the instant embodiment, the transaction operation is exemplified as involving first storing a value in a website for purchasing points to allow for deducting points to count the number of use. As shown in FIG. 4, the mobile application program 31 displays “Remaining Point: 5, Deducting 1 Point? Yes or No”. If the user selects “Yes”, then the cloud server 2 makes a deduction from the remaining point and transmits a control code 32 to the mobile electronic device 3 and the mobile application program 31 of the mobile electronic device 3 displays the control code 32 (an example of which is a QR code in this embodiment) on the mobile electronic device 3, as shown in FIG. 5. The user may then, as shown in FIG. 6, places the mobile electronic device 3 in front of the scanning element 12 to allow the scanning element 12 to scan the control code 32 and transmits a message to the control body 11, and the control body 11 then transmits message of the control code 32 to the cloud server 2 and confirms, with the cloud server 2, the accuracy of the control code 32. If it is not accurate, the cloud server 2 transmit a control signal of error to the control body 11, and the pebble bed sauna 1 makes no operation at all; and if it is accurate, then the cloud server 2 transmits a control signal of correctness to the control body 11, so that the control body 11 starts up the pebble bed sauna 1. In this way, the user may directly use the mobile application program 31 loaded in the mobile electronic device 3 to carry out the transaction operation, in combination of operation of the scanning element 12 provided on the pebble bed sauna 1 to start the pebble bed sauna 1, and there is no need for interaction with a counter clerk. This saves human labor in the operation and is more convenient and more efficient for the user.

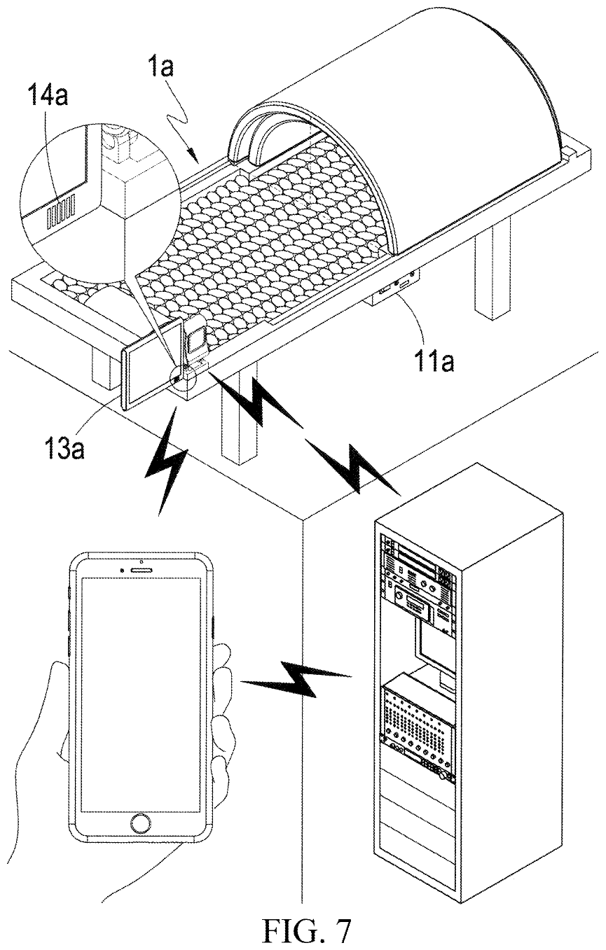

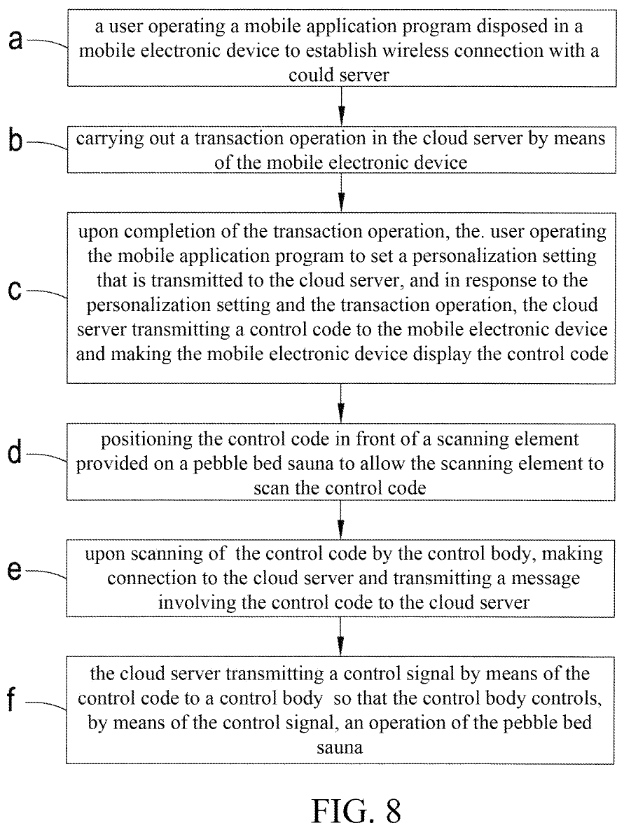

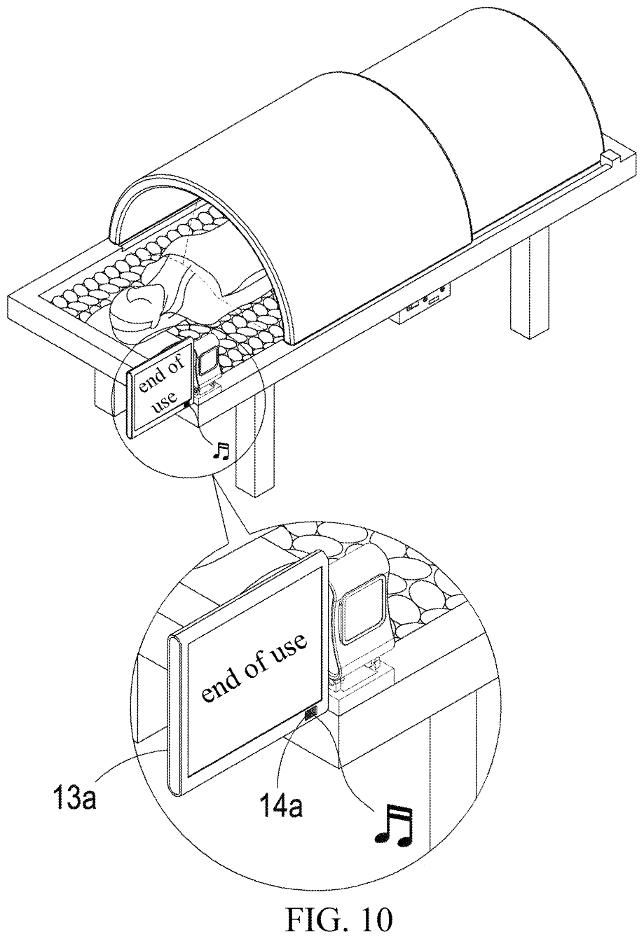

Further referring to FIGS. 7-10, the drawings clearly show that a displaying interface 13a and a reminder element 14a are provided on the pebble bed sauna 1a. In the instant embodiment, the displaying interface 13a comprises a display screen that is in information connection with the control body 11a and operable to display an operation state of the pebble bed sauna 1a, and the reminder element 14a is a speaker mounted on the displaying interface 13a. Steps of operation in the instant embodiment are similar to those of the previous embodiment, and only Step (c) has been changed and will be described as follows:

(c) upon completion of the transaction operation, the user operating the mobile application program to set a personalization setting that is transmitted to the cloud server, and in response to the personalization setting and the transaction operation, the cloud server transmitting a control code to the mobile electronic device and making the mobile electronic device display the control code.

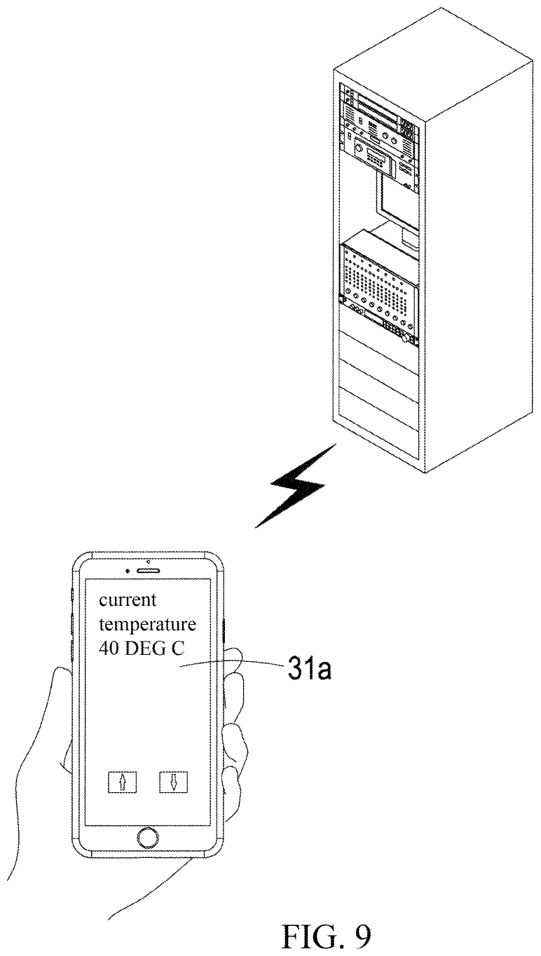

In Step (c), after the operation of transaction is completed, the user may carry out adjusting control to set up the personalization setting, such adjustment related functions that allow a user to operate the mobile application program 31a to adjust a temperature of use or a time period of use, and, as shown in FIG. 9, the mobile application program 31a may display “current temperature is 40° C.”, and an adjustment button is provided to allow the user to make the adjustment in order to match the preferred way of operation of the pebble bed sauna 1a.

Upon completion of the use, the displaying interface 13a displays “operation ends” and the reminder element 14a gives off sounds to remind the user of the completion of use in order to prevent the user from getting confused if the time of use is ended or not, leading to unnecessary wasting of time, and further enhancing convenience of use.

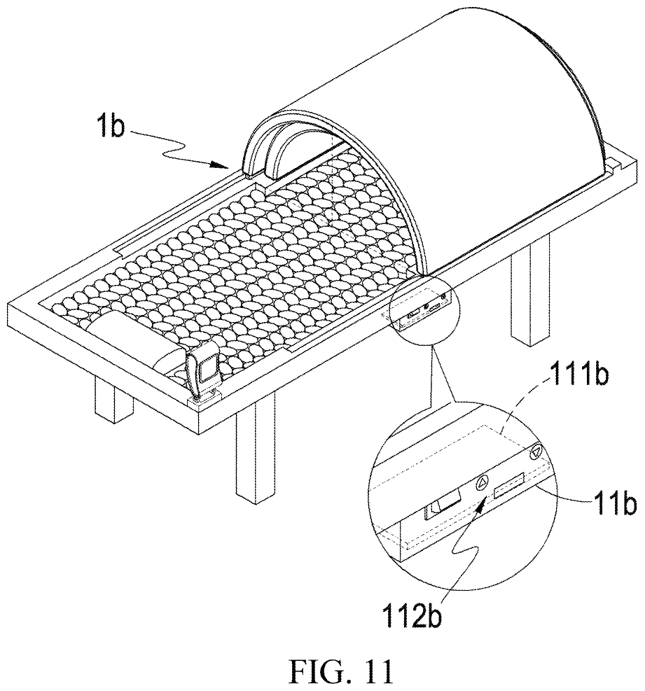

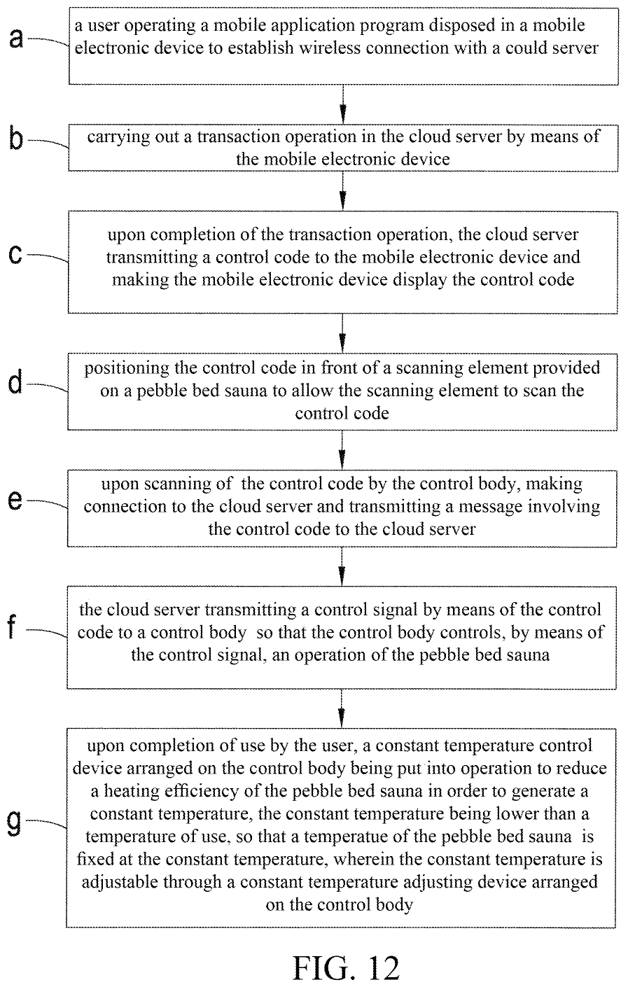

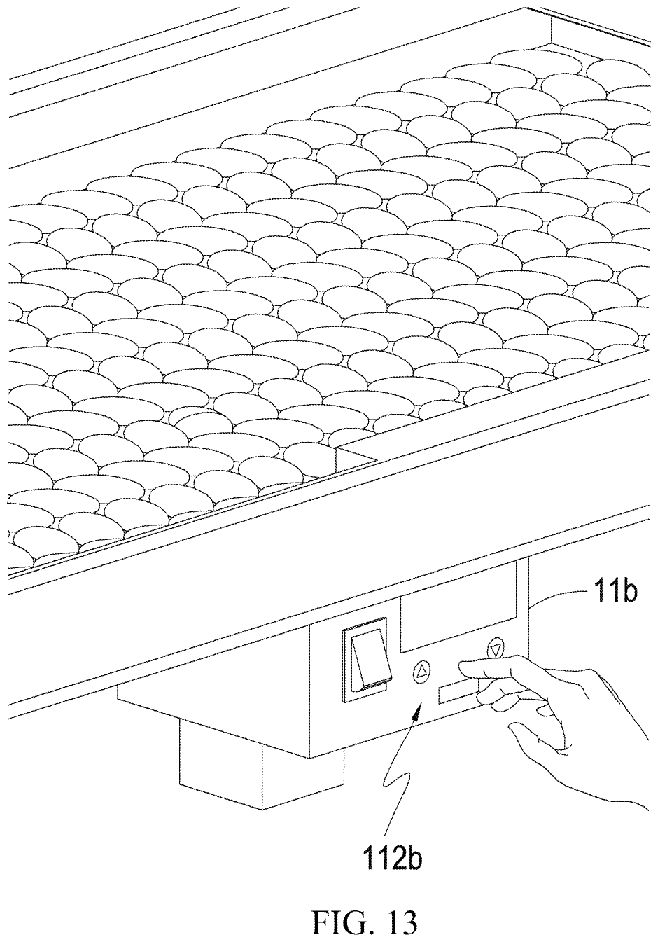

Referring to FIGS. 11-13, the drawings clearly show that the control body 11b is provided with a constant temperature control device 111b and a constant temperature adjusting device 112b in information connection with the constant temperature control device 111b. The constant temperature control device 111b involves control circuit parts arranged in the control body 11b. The constant temperature adjusting device 112b includes a control button provided on the control body 11b. Steps of operation in the instant embodiment are similar to those of the previous embodiment, and only the following additional step is added after Step (a)-Step (f):

(g) upon completion of use, the user operating a constant temperature control device arranged on the control body to reduce a heating efficiency of the pebble bed sauna in order to generate a constant temperature, wherein the constant temperature is lower than a temperature of use, so that a temperature of the pebble bed sauna is fixed at the constant temperature, wherein the constant temperature is adjustable through a constant temperature adjusting device arranged on the control body.

In the above step, wherein the user completes the use, the constant temperature control device 111b adjusts the heating efficiency of the pebble bed sauna 1b to make the temperature of the pebble bed sauna 1b lowered to a constant temperature and fixes the temperature of the pebble bed sauna 1b to the constant temperature. The constant temperature is lower than the temperature of the pebble bed sauna 1b in use and the constant temperature is adjustable through the constant temperature adjusting device 112b. In this way, the constant temperature can be adjusted according to the temperature of the surroundings, such as being set at 30 degrees Celsius in summertime in which the speed of heating may be higher, and in wintertime, the speed of heating being slower and the constant temperature is set at 35 degrees Celsius. As such, assuming a temperature of use is 40 degrees, regardless the starting point of heating is 30 degrees Celsius or 35 degrees Celsius, it is faster to reach the temperature of use as compared to starting heating from the temperature of the surroundings. Further, the constant temperature is taken as a lower bound of the operation temperature so that there is no significant waste of energy, only serving as a starting temperature for re-heating. In this way, the constant temperature could help greatly reduce the time period from the time point of heating to the time point of actual use, and also helps greatly reduce the time period of heating so as to reduce the consumption of electrical energy for heating thereby achieving the effects of environmental friendliness, electricity saving, and carbon reduction.

I claim:

1. A pebble bed sauna control device, mainly comprising:
a control body, wherein the control body is provided on a pebble bed sauna to control an operation of the pebble bed sauna;
a scanning element, wherein the scanning element is arranged at one side of the control body and is in information connection with the control body and is operable to scan a control code generated by the mobile electronic device; and
a cloud server, wherein the cloud server is operable to establish information connection with the control body and a mobile application program of the mobile electronic device to carry out a transaction operation by means of the mobile application program to generate the control code so as to allow the control body to connect, by means of the control code, with the cloud server and to control an operation of the pebble bed sauna by means of a control signal of the cloud server.

2. The pebble bed sauna control device according to claim 1, wherein the pebble bed sauna is provided with a displaying interface in information connection with the control body to display a state of the pebble bed sauna.

3. The pebble bed sauna control device according to claim 1, wherein the pebble bed sauna is provided with a reminder element in information connection with the control body to provide a reminder of the state of the pebble bed sauna.

4. The pebble bed sauna control device according to claim 1, wherein the mobile application program is operable to set a personalization setting for transmission to the cloud server to generate, in combination with the transaction operation, the control code.

5. The pebble bed sauna control device according to claim 1, wherein the control body is provided therein with a constant temperature control device and a constant temperature adjusting device arranged at one side of the constant temperature control device, wherein the constant temperature control device takes control of the pebble bed sauna to generate a constant temperature that is lower than an operation temperature and the constant temperature adjusting device is in information connection with the constant temperature control device to set a temperature level to which the constant temperature attempts to reach.

6. A pebble bed sauna control method, comprising the following steps:
(a) a user operating a mobile application program disposed in a mobile electronic device to establish wireless connection with a cloud server;
(b) carrying out a transaction operation in the cloud server by means of the mobile electronic device;
(c) upon completion of the transaction operation, the cloud server transmitting a control code to the mobile electronic device and making the mobile electronic device display the control code;
(d) positioning the control code in front of a scanning element provided on a pebble bed sauna to allow the scanning element to scan the control code;
(e) upon scanning of the control code by the control body, making connection to the cloud server and transmitting a message involving the control code to the cloud server; and
(f) the cloud server transmitting a control signal by means of the control code to a control body, so that the control body controls, by means of the control signal, an operation of the pebble bed sauna.

7. The pebble bed sauna control method according to claim 6, wherein the pebble bed sauna is provided with a displaying interface that is in information connection with the control body to display a state of the pebble bed sauna.

8. The pebble bed sauna control method according to claim 6, wherein the pebble bed sauna is provided with a reminder element that is in information connection with the control body to provide a reminder of a state of the pebble bed sauna.

9. The pebble bed sauna control method according to claim 6, wherein in Step (c), upon completion of the transaction operation, the user operates the mobile application program to set up a personalization setting that is transmittable to the cloud server to collaborate with the state of use to generate the control code.

10. The pebble bed sauna control method according to claim 6, wherein after Step (f), Step (g) is carried out, in which after end of the use by the user, a constant temperature control device arranged on the control body is operated to slow down a heating efficiency of the pebble bed sauna to generate a constant temperature, wherein the constant temperature is lower than a temperature of use, so that a temperature of the pebble bed sauna is fixed at the constant temperature, the constant temperature being adjustable through a constant temperature adjusting device arranged on the control body.
